(19) United States
(12) Patent Application Publication
(10) Pub. No.: US 2010/0026132 A1
(43) Pub. Date: Feb. 4, 2010

(54) STATOR FOR ROTATING ELECTRIC MACHINE

(75) Inventors: Tooru Ooiwa, Toyota-shi (JP); Reikichi Kaneda, Okazaki-shi (JP)

Correspondence Address: NIXON & VANDERHYE, PC, 901 NORTH GLEBE ROAD, 11TH FLOOR, ARLINGTON, VA, 22203, US

(73) Assignee: DENSO CORPORATION, Kariya-city (JP)

(21) Appl. No.: 12/533,053

(22) Filed: Jul. 31, 2009

(30) Foreign Application Priority Data
Jul. 31, 2008 (JP) 2008-197308
Aug. 4, 2008 (JP) 2008-200675

(51) Int. Cl. H02K 3/12

(52) U.S. Cl. 310/201

(57) ABSTRACT

A stator for a rotating electric machine includes a cylindrical stator core and a stator winding. The stator winding includes inserted portions, which are inserted in slots of the stator core, and connecting portions that are located outside of the slots to connect the inserted portions. Each of the inserted portions has a rectangular cross section with a pair of long sides and a pair of short sides. In each of the slots, each of those inserted portions which are located on the radially inner side has the short sides of its cross section arranged perpendicular to the radial direction of the stator core; each of those inserted portions which are located on the radially outer side has the long sides of its cross section arranged perpendicular to the radial direction. The circumferential width of each of the slots increases in the radially outward direction of the stator core.

### CROSS-REFERENCE TO RELATED APPLICATIONS

This application is based on and claims priority from Japanese Patent Applications No. 2008-197308, filed on Jul. 31, 2008, and No. 2008-200675, filed on Aug. 4, 2008, the contents of which are hereby incorporated by reference into this application.

### BACKGROUND OF THE INVENTION

1. Technical Field of the Invention

The present invention relates to stators for rotating electric machines that are used, for example, in passenger cars and trucks.

2. Description of the Related Art

International Publication No. WO 92/06527 discloses a stator for an electric motor which includes a stator winding formed by joining a plurality of electrical conductor segments. More specifically, the stator winding is formed by: inserting the conductor segments which are U-shaped into slots of a stator core of the stator from the side of one of two opposite end faces of the stator core; and joining the ends of the conductor segments on the side of the other end face of the stator core. With the above formation, the stator winding can be more regularly arranged in the slots of the stator core than in the case of forming it by winding a continuous electrical conductor. Moreover, to reduce gaps between the conductor segments and side faces of the stator core defining the slots and to thereby improve the degree of alignment of the conductor segments in the slots, each facing pair of the side faces are formed parallel to each other, making teeth of the stator core have a fan-like shape.

However, with the above formation of the stator winding, it is necessary to first prepare the U-shaped conductor segments by bending straight conductor segments by 180°; further, to insert two sides of each of the U-shaped conductor segments respectively into two different slots of the stator core, it is necessary to twist the U-shaped conductor segment at the center of the bend thereof. Consequently, a large stress will be induced inside of the bend of the conductor segment, and an insulating coat covering the conductor segment may be damaged during the bending and twisting process.

Moreover, generally, when a magnetic circuit is formed with iron, it is preferably used at a magnetic flux density slightly lower than the saturation flux density of iron. If the magnetic flux density is too low, iron cannot be fully utilized and the cross-sectional area of the magnetic circuit becomes unnecessarily large. In this case, reducing the cross-sectional area will result in only a slight increase in the magnetic reluctance of the magnetic circuit; it is thus preferable to reduce the cross-sectional area for weight saving. On the other hand, if the magnetic flux density is higher than the saturation flux density of iron, the magnetic reluctance of the magnetic circuit becomes too high and the excitation magnetic flux cannot be fully utilized. In this case, the magnetic reluctance of the magnetic circuit can be considerably lowered by slightly increasing the cross-sectional area of the magnetic circuit, thereby improving the performance of the magnetic circuit. In view of the above, it is preferable to increase the cross-sectional area of the stator core on the radially inner side and reduce the same on the radially outer side, thereby making the cross-sectional area of the stator core constant in the radial direction. In other words, it is preferable for each of the teeth of the stator core to have a constant circumferential width in the radial direction of the stator core, thereby making each of the slots of the stator core have a fan-like shape.

International Publication No. WO 2004/062065 A1, an English equivalent of which is US 2005/0238704 A1, discloses a stator as shown in FIG. 10 of the publication. In the stator, each of the teeth of the stator core has a constant circumferential width in the radial direction of the stator core; thus, each of the slots of the stator core has a fan-like shape. The stator winding has, for each of the slots of the stator core, a plurality of slot-housed portions that are housed in the slot and aligned with each other in the radial direction of the stator core. Each of the slot-housed portions has a racetrack-shaped cross section with a height in the radial direction of the stator core and a width in the circumferential direction of the same. The height-to-width ratios of the slot-housed portions gradually decrease in the radially outward direction of the stator core. Moreover, the slot-housed portions are formed by using a pressing machine, and the pressing force is gradually changed to obtain the different height-to-width ratios of the slot-house portions. Consequently, with the above formation, it is difficult to minimize the time and the number of steps for forming the stator winding.

International Publication No. WO 2008/044703 discloses a stator in which each of the slots of the stator core includes first and second portions. The first portion is located radially inside of the second portion, and has a smaller circumferential width than the second portions. The stator winding includes a plurality of first slot-housed portions, which are housed in the first portions of the slots of the stator core, and a plurality of second slot-housed portions that are housed in the second portions of the slots. The first slot-housed portions have a smaller circumferential width than the second slot-housed portions. Consequently, with the above formation, it is necessary to prepare two types of electrical conductors with different cross sections for forming the stator winding.

Japanese Patent First Publication No. 2008-48488 discloses a stator in which the stator winding is formed with a plurality of U-shaped conductor segments. Moreover, each of the U-shaped conductor segments is formed by twisting a straight conductor segment by 180° and then bending both ends of the conductor segment toward the same direction. However, with the above formation, when a twist width L as illustrated in FIG. 2 of the publication is insufficiently long, an insulating coat covering the conductor segment may be damaged during the twisting process.

### SUMMARY OF THE INVENTION

According to one aspect of the present invention, there is provided a stator for a rotating electric machine. The stator includes a hollow cylindrical stator core and a stator winding mounted on the stator core. The stator core has a plurality of slots formed therein. The slots are arranged in the circumferential direction of the stator core at predetermined intervals. The stator winding includes a plurality of inserted portions, which are inserted in the slots of the stator core, and a plurality of connecting portions that are located outside of the slots to connect the inserted portions. Each of the inserted portions of the stator winding has a rectangular cross section with a pair of long sides and a pair of short sides or an elliptical cross section with a major axis and a minor axis. For each of the slots, those of the inserted portions of the stator winding which are inserted in the slot are aligned in the radial direction of the stator core and sorted into first and second groups; the first group of the inserted portions is located radially inside of the second group of the inserted portions. Each of the inserted portions of the first group has the short sides or minor axis of its cross section arranged perpendicular to the radial direction of the stator core. Each of the inserted portions of the second group has the long sides or major axis of its cross section arranged perpendicular to the radial direction of the stator core. The width of each of the slots of the stator core in the circumferential direction of the stator core increases in the radially outward direction of the stator core.

According to another aspect of the present invention, there is provided a stator for a rotating electric machine. The stator includes a hollow cylindrical stator core and a stator winding mounted on the stator core. The stator core has a plurality of slots formed therein. The slots are arranged in the circumferential direction of the stator core at predetermined intervals. The stator winding includes a plurality of inserted portions, which are inserted in the slots of the stator core, and a plurality of connecting portions that are located outside of the slots to connect the inserted portions. Each of the inserted portions of the stator winding has a rectangular cross section with a pair of long sides and a pair of short sides or an elliptical cross section with a major axis and a minor axis. For each of the slots, those of the inserted portions of the stator winding which are inserted in the slot are aligned in the radial direction of the stator core. Each of the connecting portions of the stator winding has a rectangular cross section with a pair of long sides and a pair of short sides or an elliptical cross section with a major axis and a minor axis. Each of the connecting portions connects a pair of the inserted portions of the stator winding which are respectively inserted in a pair of the slots of the stator core and located at different radial positions. Each of the connecting portions consists of a radially inner portion, a radially outer portion, and a turn portion between the radially inner and radially outer portions. The radially inner portion extends, from the radially inner one of the pair of the inserted portions, toward the turn portion in the circumferential direction of the stator core and away from the stator core in the axial direction. The turn portion is, in the connecting portion, furthest from the stator core. The radially outer portion extends, from the turn portion, toward the radially outer one of the pair of the inserted portions in the circumferential direction of the stator core and toward the stator core in the axial direction. In the radially inner portion, the connecting portion has the long sides or major axis of its cross section arranged parallel to the radial direction of the stator core. In the radially outer portion, the connecting portion has the long sides or major axis of its cross section arranged perpendicular to the radial direction of the stator core. In the turn portion, the arrangement direction of the long sides or major axis of the cross section of the connecting portion is smoothly turned by 90°.

### BRIEF DESCRIPTION OF THE DRAWINGS

The present invention will be understood more fully from the detailed description given hereinafter and from the accompanying drawings of one preferred embodiment of the invention, which, however, should not be taken to limit the invention to the specific embodiment but are for the purpose of explanation and understanding only.

In the accompanying drawings:

FIG. 1 is a partially cross-sectional view showing the overall configuration of an automotive alternator according to the preferred embodiment of the invention;

FIG. 2 is a schematic circuit diagram of the alternator;

FIG. 3 is a schematic perspective view showing the configuration of conductor segments for forming a stator winding of the alternator;

FIG. 4 is a schematic perspective view illustrating a process of inserting the conductor segments into slots formed in a stator core of the alternator;

FIGS. 5A and 5B are schematic perspective views illustrating a process of forming the conductor segments;

FIG. 6 is a schematic circuit diagram showing the equivalent circuit of a three-phase winding of the stator winding;

FIG. 7 is a schematic connection diagram showing part of the stator winding;

FIG. 8 is a schematic cross-sectional view illustrating the arrangement of inserted portions of the stator winding in each of the slots of the stator core;

FIG. 9 is a schematic cross-sectional view illustrating a modification of the stator core;

FIG. 10 is a schematic view illustrating the deformation of an electrical conductor with a square cross section caused by 90° twisting;

FIG. 11 is a schematic view illustrating the deformation of an electrical conductor with a square cross section caused by 180° twisting;

FIG. 12 is a schematic view giving a comparison between the deformations of the electrical conductors caused by 90° twisting and 180° twisting;

FIG. 13 is a schematic cross-sectional view illustrating a modification of the stator wherein the inserted portions of the stator winding have an elliptical cross section and the side faces of teeth of the stator core are flat;

FIG. 14 is a schematic cross-sectional view illustrating another modification of the stator wherein the inserted portions of the stator winding have an elliptical cross section and the side faces of teeth of the stator core are stepped; and

FIG. 15 is a schematic cross-sectional view illustrating yet another modification of the stator wherein the inserted portions of the stator winding have a square cross section.

### DESCRIPTION OF PREFERRED EMBODIMENT

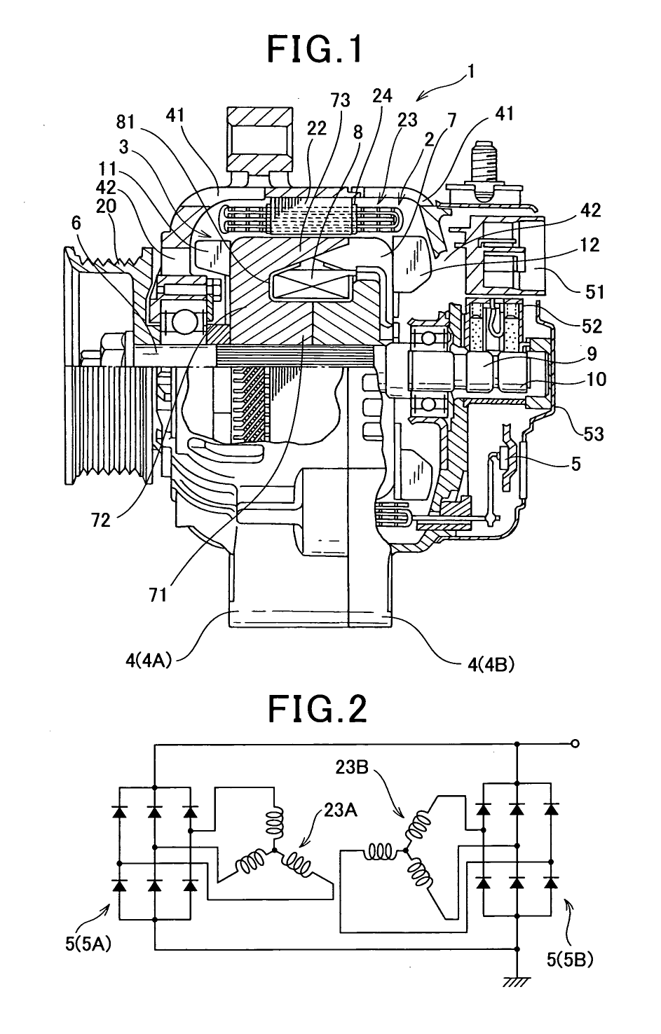

FIG. 1 shows the overall configuration of an automotive alternator 1 according to an embodiment of the invention. FIG. 2 shows the electrical circuit of the alternator 1. The alternator 1 is designed to be used in a motor vehicle, such as a passenger car or a truck.

As shown in FIGS. 1 and 2, the alternator 1 includes a stator 2, a rotor 3, a frame 4, and a rectifier 5, a voltage regulator 51, a brush device 52, and a protecting cover 53.

The stator 2 includes: a hollow cylindrical stator core 22 having a plurality of (e.g., 96 in the present embodiment) slots 25 arranged in the circumferential direction of the stator core 22 at predetermined intervals; a stator winding 23 that is formed by joining a plurality of electrical conductor segments inserted in the slots 25 of the stator core 22; and an insulator 24 that electrically isolates the stator core 22 from the stator winding 23.

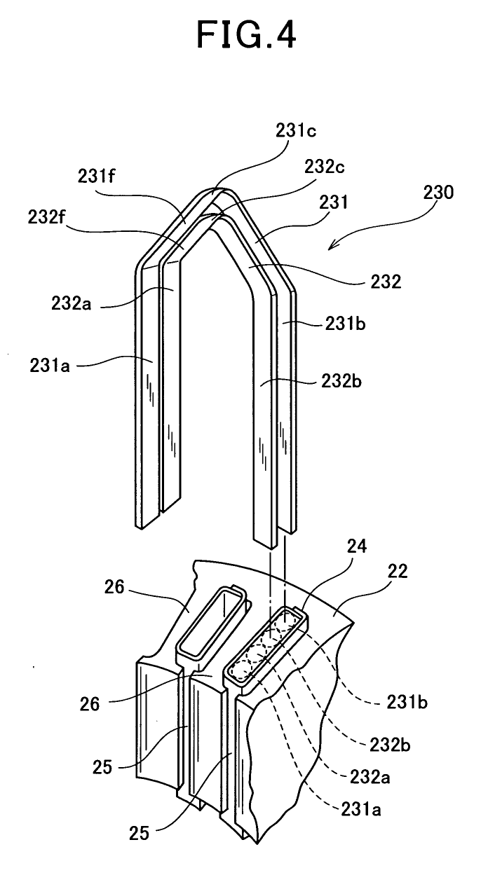

The stator core 22 is formed by laminating a plurality of thin steel sheets. The stator core 22 also has a plurality of teeth 26 (shown in FIG. 4) each of which is formed between an adjacent pair of the slots 25 in the circumferential direction of the stator core 22.

The stator winding 23 includes a plurality of multi-phase windings. For example, as shown in FIG. 2, in the present embodiment, the stator winding 23 includes first and second three-phase windings 23A and 23B that are mounted on the stator core 22 away from each other by a mechanical angle corresponding to an electrical angle of 30°. The first three-phase winding 23A consists of an X-phase winding, a Y-phase winding, and a Z-phase winding. On the other hand, the second three-phase winding 23B consists of a U-phase winding, a V-phase winding, and a W-phase winding.

The rotor 3 includes a shaft 6, a pair of Lundell-type magnetic pole cores 7, a field winding 8, a pair of slip rings 9 and 10, a mixed-flow cooling fan 11, and a centrifugal cooling fan 12.

The shaft 6 has a pulley 20 mounted on an end portion thereof (i.e., a left end portion in FIG. 1), so that it can be driven by an internal combustion engine of the vehicle via the pulley 20.

Each of the magnetic pole cores 7 has a hollow cylindrical boss portion 71, a disc portion 72, and a plurality of magnetic pole claws 73. The boss portion 71 is fitted on the shaft 6 so as to rotate along with the rotary shaft 6. The disc portion 72 extends radially outward from an axially outer part of the boss portion 71. Each of the magnetic pole claws 73 axially extends from a radially outer part of the disc pardon 72.

The magnetic pole cores 7 are assembled together so that the magnetic pole claws 73 of one of the magnetic pole cores 7 are interleaved with the magnetic pole claws 73 of the other magnetic pole core 7.

The field winding 8 is wound around both the boss portions 71 of the magnetic pole cores 7 via an electrically insulating paper 81. The field winding 8 also abuts, under a suitable pressure, a radially inner part of each of the magnetic pole claws 73 of the magnetic pole cores 7 via the electrically insulating paper 81.

In addition, the electrically insulating paper 81 is made up of a resin-impregnated paper sheet and adhered to the field winding 8 by a heat treatment. The electrically insulating paper 81 surrounds the field winding 8 so as to electrically insulate the field winding 8 from the magnetic pole cores 7.

The slip rings 9 and 10 are provided on an end portion of the shaft 6 on the opposite side to the pulley 20 (i.e., a right end portion of the shaft 6 in FIG. 1).

The mixed-flow cooling fan 11 is fixed, for example by welding, to an axial end face of the disc portion 72 of that one of the magnetic pole cores 7 which is located on the pulley 20 side (i.e., the left side in FIG. 1). On the other hand, the centrifugal cooling fan 12 is fixed, for example by welding, to an axial end face of the disc portion 72 of the other magnetic pole core 7 which is located an the opposite side to the pulley 20 (i.e., the right side in FIG. 1). Moreover, the mixed-flow cooling fan 11 has a smaller blade-area perpendicular to the rotation direction of the rotor 3 than the centrifugal cooling fan 12.

The frame 4 receives both the stator 2 and the rotor 3 so that the rotor 3 is rotatably supported by the frame 4 and the stator 2 is fixed on the radially outer side of the rotor 3 with a predetermined radial gap between the stator 2 and the rotor 3. In other words, the stator 2 surrounds the radially outer periphery of the rotor 3 with the predetermined radial gap therebetween. In the present embodiment, the frame 4 is composed of a pair of frame pieces 4A and 4B that are connected together by means of a plurality of bolts (not shown). Moreover, the frame 4 has a plurality of cooling air discharge openings 41 and a plurality of cooling air suction openings 42. The cooling air discharge openings 41 are so formed in the frame 4 as to face those portions of the stator winding 23 which project outside of the stator core 22. The cooling air suction openings 42 are each formed through one of the axial end walls of the frame pieces 4A and 4B.

The rectifier 5 is fixed to the outer surface of the axial end wall of the frame piece 4B and includes first and second three-phase full-wave rectification circuits 5A and 5B. As shown in FIG. 2, the first and second rectification circuits 5A and 5B are configured to respectively full-wave rectify the three-phase AC powers output from the first and second three-phase windings 23A and 23B of the stator winding 23.

The voltage regulator 51 is also fixed to the outer surface of the axial end wall of the frame piece 4B. The voltage regulator 51 is configured to regulate the output voltage of the alternator 1 by controlling field current supplied to the field winding 8.

The brush device 52 is also fixed to the outer surface of the axial end wall of the frame piece 4B. The brush device 52 includes a pair of brushes that are respectively arranged on the radially outer peripheries of the slip rings 9 and 10, so as to transmit the field current to the field winding 8 via the slip rings 9 and 10.

The protecting cover 53 is so fixed to the frame piece 4B that it covers all of the rectifier 5, the voltage regulator 51, and the brush device 52, thereby protecting them from foreign matter, such as water and dust.

The automotive alternator 1 having the above-described configuration operates in the following way. When torque is transmitted from the engine to the pulley 20 via, for example, a belt (not shown), the rotor 3 is driven by the torque to rotate in a predetermined direction. During the rotation of the rotor 3, the field current is supplied to the field winding 8, thereby magnetizing the magnetic pole claws 73 of the magnetic pole cores 7 to create a rotating magnetic field. The rotating magnetic field induces the three-phase AC powers in the first and second three-phase windings 23A and 23B of the stator winding 23. Then, the first and second rectification circuits 5A and 5B of the rectifier 5 respectively full-wave rectify the three-phase AC powers output from the first and second three-phase windings 23A and 23B into DC power. The voltage regulator 51 regulates the voltage of the DC power, which represents the output voltage of the alternator 1, by controlling the field current supplied to the field winding 8.

Next, the configuration of the stator 2 of the alternator 1 will be described in more detail.

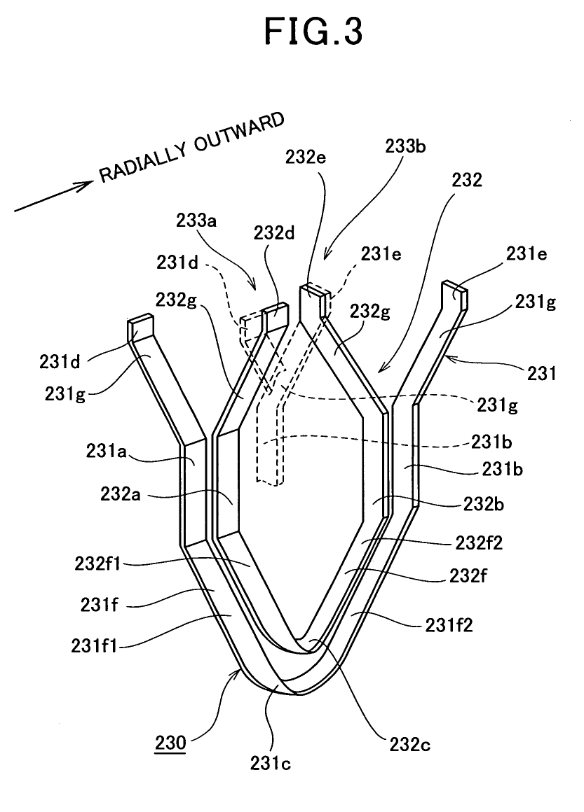

Referring to FIGS. 3-5, the stator winding 23 includes a plurality of electrical conductors inserted in the slots 25 of the stator core 22. Moreover, the number of the electrical conductors inserted in each of the slots 25 is equal to 2×n, where n is an integer greater than or equal to 2.

More specifically, in the present embodiment, in each of the slots 25 of the stator core 22, there are inserted four electrical conductors that are aligned in the radial direction of the stator core 22 and arranged from the radially inner end of the slot 25 in the order of an inside conductor 231a, an inside-center conductor 232a, an outside-center conductor 232b, and an outside conductor 231b.

Each of the electrical conductors inserted in the slots 25 of the stator core 22 makes up an inserted portion of the stator winding 23. Moreover, each of the inserted portions of the stator winding 23 (i.e., each of the electrical conductors) has a rectangular cross section with a pair of long sides and a pair of short sides. For each of the slots 25, the inside conductor 231a in the slot 25 is connected, via a connecting conductor, to the outside conductor 231b in another of the slots 25 which is located away from the slot 25 by one magnetic pole pitch in the clockwise direction; the connecting conductor is located on the side of a first axial end of the stator core 22 and has a turn portion 231c. Moreover, for each of the slots 25, the inside-center conductor 232a in the slot 25 is connected, via a connecting conductor, to the outside-center conductor 232b in another of the slots 25 which is located away from the slot 25 by one magnetic pole pitch in the clockwise direction; the connecting conductor is located on the side of the first axial end of the stator core 22 and has a turn portion 232c.

Consequently, on the side of the first axial end of the stator core 22, each of the turn portions 232c of the connecting conductors that respectively connect pairs of the inside-center conductors 232a and the outside-center conductors 232b is covered by a corresponding one of the turn portions 231c of the connecting conductors that respectively connect pairs of the inside conductors 231a and the outside conductors 232b.

Further, for each of the slots 25, the inside-center conductor 232a in the slot 25 is joined, on the side of a second axial end of the stator core 22, to the inside conductor 231a in another of the slots 25 which is located away from the slot 25 by one magnetic pole pitch in the clockwise direction, thereby forming a joining portion 233a. Moreover, for each of the slots 25, the outside conductor 231b in the slot 25 is joined, on the side of the second axial end of the stator core 22, to the outside-center conductor 232b in another of the slots which is located away from the slot 25 by one magnetic pole pitch in the clockwise direction, thereby forming a joining portion 233b.

Consequently, on the side of the second axial end of the stator core 22, each of the joining portions 233a is positioned away from a corresponding one of the joining portions 233b both in the radial and circumferential directions of the stator core 22.

Furthermore, in the present embodiment, each connected set of one of the inside conductors 231a, one of the outside conductors 231b, and one of the connecting conductors is formed in one piece construction by using a substantially U-shaped electrical conductor segment 231. Similarly, each connected set of one of the inside-center conductors 232a, one of the outside-center conductors 232b, and one of the connecting conductors is formed in one piece construction by using a substantially U-shaped electrical conductor segment 232.

In other words, in the present embodiment, all of the conductors 231a, 232a, 232b, 231b, and the connecting conductors are formed with a plurality of conductor segment pairs 230; each of the conductor segment pairs 230 consists of one of the conductor segments 231 and one of the conductor segments 232.

More specifically, each of the conductor segments 231 has a rectangular cross section with a pair of long sides and a pair of short sides. Each of the conductor segments 231 includes: two straight portions 231a and 231b that respectively make up one of the inside conductors 231a and one of the outside conductors 231b; a connecting portion 231f that makes up the connecting conductor for connecting the inside conductor 231a and the outside conductor 231b; an opposite pair of end portions 231d and 231e; and a pair of connecting portions 231g that respectively connect the straight portions 231a and 231b to the end portions 231d and 231e. On the other hand, each of the conductor segments 232 also has a rectangular cross section with a pair of long sides and a pair of short sides. Each of the conductor segments 232 includes: two straight portions 232a and 232b that respectively make up one of the inside-center conductors 232a and one of the outside-center conductors 232b; a connecting portion 232f that makes up the connecting conductor for connecting the inside-center conductor 232a and the outside-center conductor 232b; an opposite pair of end portions 232d and 232e; and a pair of connecting portions 232g that respectively connect the straight portions 232a and 232b to the end portions 232d and 232e.

Moreover, each of the ends 231d of the conductor segments 231 is joined, for example by welding or brazing, to a corresponding one of the ends 232d of the conductor segments 232, forming one joining portion 233a. On the other hand, each of the ends 231e of the conductor segments 231 is joined, for example by welding or brazing, to a corresponding one of the ends 232e of the conductor segments 232, forming one joining portion 233b.

Consequently, all of the connecting portions 231f and 231g of the conductor segments 231, the connecting portions 232f and 232g of the conductor segments 232, and the joining portions 233a and 233b are located outside of the slots 25 of the stator core 22, thereby being exposed to the flow of cooling air created by the cooling fans 11 and 12.

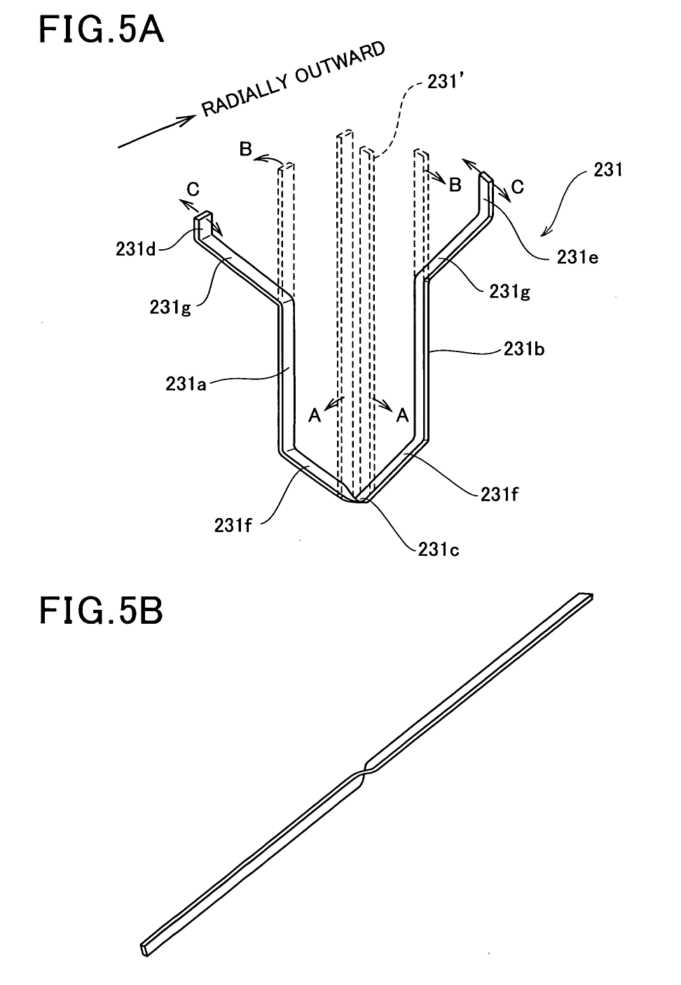

The above-described conductor segments 231 and 232 can be formed almost in the same way. Therefore, only the process of forming one of the conductor segments 231 will be described hereinafter with reference to FIGS. 5A and 5B.

First, a copper wire having a rectangular cross section is twisted at the longitudinal center thereof by 90° as shown in FIG. 5B. Then, the copper wire is bent into a U-shaped conductor 231′ as shown with dashed lines in FIG. 5A. The conductor 231′ is further deformed in A directions in FIG. 5A to form the turn portion 231c. Thereafter, the conductor 231′ is further bent at two points to form the straight portions 231a and 231b and the connecting portion 231f.

The straight portions 231a and 231b of the conductor 231′ are respectively inserted, via the insulator 24, into a pair of the slots 25 of the stator core 22 from the side of the first axial end of the stator core 22; the pair of the slots 25 are away from each other in the circumferential direction C of the stator core 22 by one magnetic pole pitch. Then, the conductor 231′ is further bent, on the side of the second axial end of the stator core 22, at two points in directions B in FIG. 5A to form the connecting portions 231g. Thereafter, the conductor 231′ is further bent, on the side of the second axial end of the stator core 22, at two points in the circumferential direction C of the stator core 22 to form the end portions 231d and 231e. As a result, the conductor segment 231 as shown in FIG. 5A is obtained.

In practice, as shown in FIG. 4, for each of the conductor segment pairs 230, the conductor segments 231 and 232 constituting the conductor segment pair 230 are together inserted into a pair of the slots 25 so as to have the turn portion 232c of the conductor segment 232 covered by the turn portion 231c of the conductor segment 231 on the side of the first axial end of the stator core 22; the pair of the slots 25 are away from each other in the circumferential direction of the stator core 22 by one magnetic pole pitch. More specifically, each of the conductor segments 231 and 232 is made of a coated copper wire having a rectangular cross section, twisted and bent into a substantially U-shape, and press-fit into the pair of the slots 25 to have the side faces thereof abutting the corresponding side faces of the teeth 26 via the insulator 24. Further, as shown in FIG. 3, the connecting portions 231g and 232g of the conductor segments 231 and 232 are formed, on the side of the second axial end of the stator core 22, such that each adjacent pair of one of the connecting portion 231g and one of the connecting portion 232g extend away from each other in the circumferential direction of the stator core 22. Thereafter, the end portions 231d and 231e of the conductor segments 231 and the end portions 232d and 232e of the conductor segments 232 are formed to extend in the axial direction of the stator core 22.

Moreover, as shown in FIG. 3, for each of the conductor segments 231, the connecting portion 231f consists of a radially inner portion 231f1, a radially outer portion 231f2, and the turn portion 231c between the radially inner and radially outer portions 231f and 232f. The radially inner portion 231f1 extends from the straight portion 231a toward the turn portion 231c in the circumferential direction of the stator core 22 and away from the stator core 22 in the axial direction. The turn portion 231c is, in the conductor segment 231, furthest from the stator core 22. The radially outer portion 231f2 extends from the turn portion 231c toward the straight portion 231b in the circumferential direction of the stator core 22 and toward the stator core 22 in the axial direction. Further, the straight portion 231a which makes up one of the inside conductors 231a in the slots 25 has the short sides of its cross section arranged perpendicular to the radial direction of the stator core 22; the straight portion 231b which makes up one of the outside conductors 231b in the slots 25 has the long sides of its cross section arranged perpendicular to the radial direction of the stator core 22. Furthermore, the radially inner portion 231f1 has the long sides of its cross section arranged almost parallel to the radial direction of the stator core 22; the radially outer portion 231f2 has the long sides of its cross section arranged almost perpendicular to the radial direction of the stator core 22; the arrangement direction of the long sides of the cross section of the connecting portion 231f is smoothly turned in the turn portion 231c by 90°.

Similarly, for each of the conductor segments 232, the connecting portion 232f consists of a radially inner portion 232f1, a radially outer portion 232f2, and the turn portion 232c between the radially inner and radially outer portions 232f1 and 232f2. The radially inner portion 232f1 extends from the straight portion 232a toward the turn portion 232c in the circumferential direction of the stator core 22 and away from the stator core 22 in the axial direction. The turn portion 232c is, in the conductor segment 232, furthest from the stator core 22. The radially outer portion 232f2 extends from the turn portion 232c toward the straight portion 232b in the circumferential direction of the stator core 22 and toward the stator core 22 in the axial direction. Further, the straight portion 232a which makes up one of the inside-center conductors 232a in the slots 25 has the short sides of its cross section arranged perpendicular to the radial direction of the stator core 22; the straight portion 232b which makes up one of the outside-center conductors 232b in the slots 25 has the long sides of its cross section arranged perpendicular to the radial direction of the stator core 22. Furthermore, the radially inner portion 232f1 has the long sides of its cross section arranged almost parallel to the radial direction of the stator core 22; the radially outer portion 232f2 has the long sides of its cross section arranged almost perpendicular to the radial direction of the stator core 22; the arrangement direction of the long sides of the cross section of the connecting portion 232f is smoothly turned in the turn portion 232c by 90°.

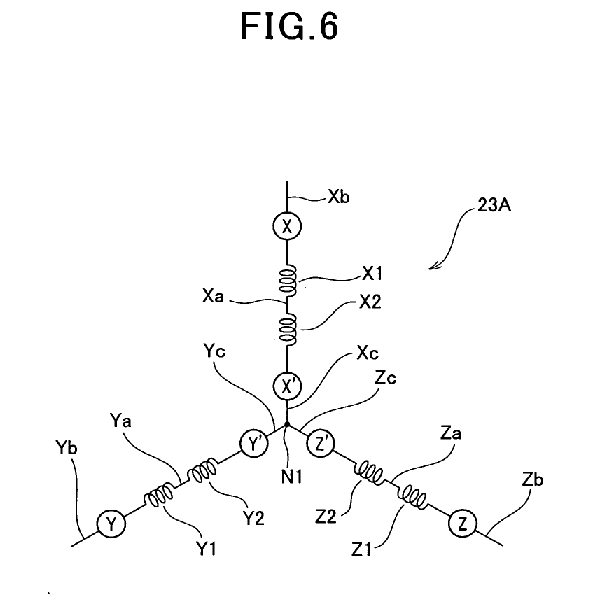

FIG. 6 shows the equivalent circuit of the first three-phase winding 23A of the stator winding 23.

As described previously, the stator winding 23 includes the first and second three-phase windings 23A and 23B, the outputs of which are respectively rectified by the first and second rectification circuits 5A and 5B of the rectifier 5. In the present embodiment, the first and second three-phase windings 23A and 23B have the same configuration; therefore, only the three-phase winding 23A will be described in detail hereinbelow.

The three-phase winding 23A consists of the X-phase, Y-phase, and Z-phase windings that are Y-connected. Further, each of the X-phase, Y-phase, and Z-phase windings includes a pair of windings that are so wound around the stator core 22 as to be different from each other by 180° in electrical angle. Moreover, the pair of windings are reversely series-connected, via a connecting conductor, so as to be in phase with each other.

More specifically, the X-phase winding includes a pair of windings X1 and X2 that are so wound around the stator core 22 as to be different from each other by 180° in electrical angle. The windings X1 and X2 are reversely series-connected, via a connecting conductor Xa, so as to be in phase with each other. The connecting conductor Xa is made up of a conductor segment that is different from the conductor segments 231 and 232. Moreover, a lead Xb is provided, on the side X of the winding X1 opposite to the connecting conductor Xa, to connect the winding X1 to the rectifier 5. On the other hand, a lead Xc is provided, on the side X′ of the winding X2 opposite to the connecting conductor Xa, to connect the winding X2 to the neutral point N1 at which the X-phase, Y-phase, and Z-phase windings are connected to each other.

The Y-phase winding includes a pair of windings Y1 and Y2 that are so wound around the stator core 22 as to be different from each other by 180° in electrical angle. The windings Y1 and Y2 are reversely series-connected, via a connecting conductor Ya, so as to be in phase with each other. The connecting conductor Ya is also made up of a conductor segment that is different from the conductor segments 231 and 232. Moreover, a lead Yb is provided, on the side Y of the winding Y1 opposite to the connecting conductor Ya, to connect the winding Y1 to the rectifier 5. On the other hand, a lead Yc is provided, on the side Y′ of the winding Y2 opposite to the connecting conductor Ya, to connect the winding Y2 to the neutral point N1.

The Z-phase winding includes a pair of windings Z1 and Z2 that are so wound around the stator core 22 as to be different from each other by 180° in electrical angle. The windings Z1 and Z2 are reversely series-connected, via a connecting conductor Za, so as to be in phase with each other. The connecting conductor Za is also made up of a conductor segment that is different from the conductor segments 231 and 232. Moreover, a lead Zb is provided, on the side Z of the winding Z1 opposite to the connecting conductor Za, to connect the winding Z1 to the rectifier 5. On the other hand, a lead Zc is provided, on the side Z′ of the winding Z2 opposite to the connecting conductor Za, to connect the winding Z2 to the neutral point N1.

In addition, each of the connecting conductors Xa, Xb, and Xc and leads Xb, Xc, Yb, Yc, Zb, and Zc is covered with an insulating coat which has higher insulting properties than those for the conductor segments 231 and 232.

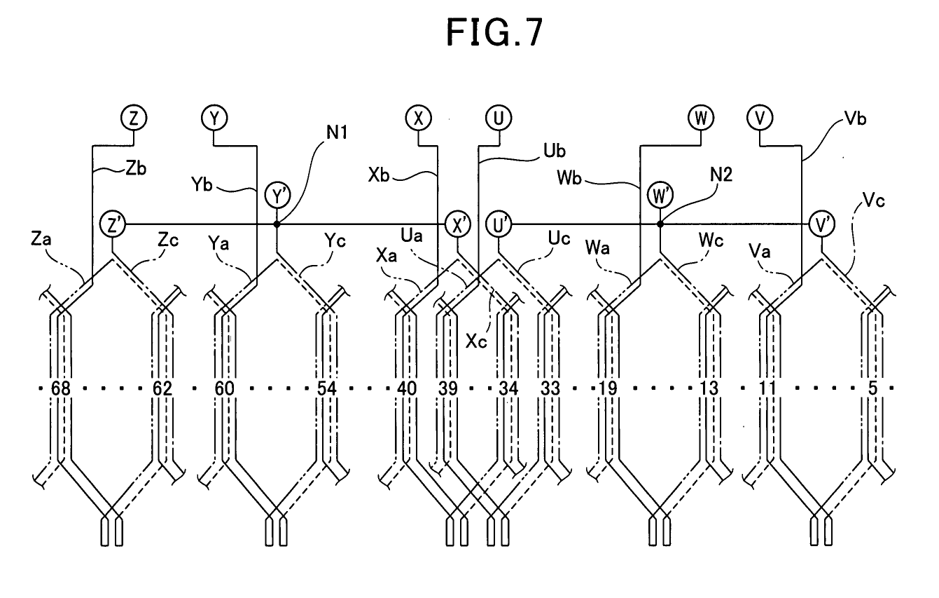

FIG. 7 shows part of the stator winding 23, where numerals, such as 68, respectively represent the numbers of the slots 25 in the stator core 22, and N1 and N2 respectively represent the neutral points of the Y-connected three-phase windings 23A and 23B. In addition, in FIG. 7, for each of the slots 25, the 1-dot chain line, dashed line, solid line, and 2-dot chain line respectively represent the inside conductor 231a, inside-center conductor 231a, outside-center conductor 232b, and outside conductor 231b inserted in the slot 25.

As shown in FIG. 7, in the case of, for example, the X-phase winding which includes the pair of X1 and X2 windings, the winding X1 is wound over almost the entire circumference of the stator core 22 at 5-slot intervals to have its ends respectively in the 40^{th} and 34^{th} slots; the winding X2 is also wound over almost the entire circumference of the stator core 22 at 5-slot intervals to have its ends respectively in the 40^{th} and 34^{th} slots. One end of the winding X1 which is in the 40^{th} slot is connected to the rectifier 5 via the lead Xb. One end of the winding X2 which is in the 34^{th} slot is connected to the neutral point N1 via the lead Xc. The other end of the winding X1 which is in the 34^{th} slot is connected, via the connecting conductor Xa, to the other end of the winding X2 which is in the 40^{th} slot.

As described above, in the present embodiment, the stator winding 23 includes a plurality of inserted portions (i.e., the electrical conductors 231a, 232a, 232b, and 231b) inserted in the slots 25 of the stator core 22. Each of the inserted portions has a rectangular cross section with a pair of long sides and a pair of short sides.

In each of the slots 25, the inserted portions are aligned in the radial direction of the stator core 22 and sorted into first and second groups. The first group of the inserted portions is located radially inside of the second group of the inserted portions. The first and second groups each include n of the inserted portions in the slot 25.

Each of the n inserted portions of the first group (i.e., the inside and inside-center conductors 231a and 232a) has the short sides of its cross section arranged perpendicular to the radial direction of the stator core 22. Each of the n inserted portions of the second group (i.e., the outside-center and outside conductors 232b and 231b) has the long sides of its cross section arranged perpendicular to the radial direction of the stator core 22. The circumferential width of each of the slots 25 of the stator core 22 increases in the radially outward direction of the stator core 22.

With the above configuration, it is possible to form the inserted portions of the stator winding 23 with connected conductor pairs (i.e., the pairs of the conductors 231a and 231b and the pairs of the conductors 232a and 232b). Consequently, in the case of forming the inserted portions by pressing electrical conductors with a circular cross section, it is possible to reduce the number of times of pressing the electrical conductors. Otherwise, in the case of forming the inserted portions by employing electrical conductors with different rectangular cross sections, it is possible to reduce the number of types of the electrical conductors. Moreover, with the circumferential width of each of the slots 25 increasing in the radially outward direction, it is possible to improve the degree of alignment of the inserted portions of the stator winding 23 in each of the slots 25; it is also possible to make the circumferential width of each of the teeth 26 of the stator core 22 almost constant in the radial direction, thereby optimizing the magnetic circuit formed in the stator 2.

Further, in the present embodiment, in each of the slots 25 of the stator core 22, there are inserted n pairs of the inserted portions of the stator winding 23, where n is an integer greater than or equal to 2. The n pairs have different ratios of length between Si and Li, where Si and Li respectively represent the short sides and long sides of the cross section of each of the inserted portion of the i^{th} pair, i=1, 2, . . . , n. The two inserted portions of each of the n pairs are respectively sorted into the first and second groups. All of the n inserted portions of the first group are arranged in the radially outward direction of the stator core 22 in the order of S1, S2, . . . , Sn−1, Sn. On the other hand, all of the n inserted portions of the second group are arranged in the radially outward direction of the stator core 22 in the order of Ln, Ln−1, . . . , L2, L1. Moreover, there is satisfied a relationship of S1≦S2≦ . . . ≦Sn−1≦Sn≦Ln≦Ln−1, ≦Ln, . . . , ≦L2≦L1.

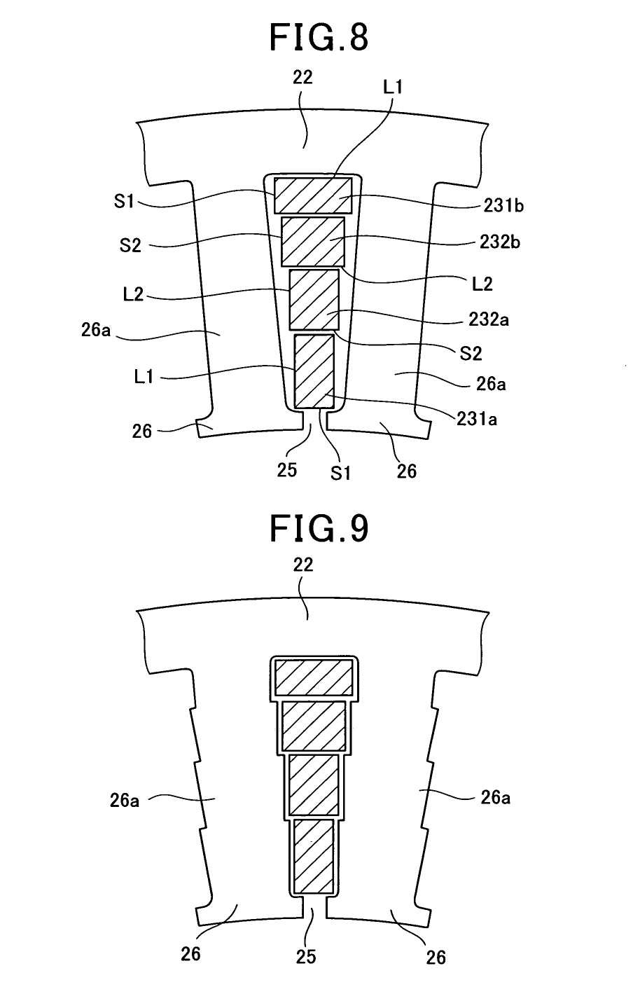

More specifically, as shown in FIG. 8, in the present embodiment, in each of the slots 25 of the stator core 22, there are inserted two pairs of the inserted portions of the stator winding 23 (i.e., the pair of the conductors 231a and 231b and the pair of conductors 232a and 232b). The cross section of each of the inserted portions of the first pair has the long sides L1 and the short sides S1. The cross section of each of the inserted portions of the second pair has the long side L2 and the short sides S1. The ratio of length between S1 and L1 is different from that between S2 and L2. The two inserted portions of the first pair (i.e., the conductors 231a and 231b) are respectively sorted into the first and second groups. The two inserted portions of the second pair (i.e., the conductors 232a and 232b) are also respectively sorted into the first and second groups. Both the inserted portions of the first group (i.e., the conductors 231a and 232a) are arranged in the radially outward direction of the stator core 22 in the order of S1 and S2. Both the two inserted portions of the second group (i.e., the conductors 232b and 231b) are arranged in the radially outward direction of the stator core 22 in the order of L2 and L1. Moreover, there is satisfied S1<S2<L2<L1. In addition, it is also possible for the inserted portions of the second pair (i.e., the conductors 232a and 232b) to have a square cross section, so that S2=L2. As a result, there is satisfied S1<S2=L2<L1. It is also possible to set S1=S2 or L1=L2.

With the above configuration, in the case of forming the inserted portions by pressing electrical conductors with a circular cross section, it is possible to reduce by half the number of times of pressing the electrical conductors. Otherwise, in the case of forming the inserted portions by employing electrical conductors with different rectangular cross sections, it is possible to reduce by half the number of types of the electrical conductors.

Moreover, with the above configuration, the circumferential widths of the inserted portions of the stator winding 23 decrease in the radially inward direction of the stator core 22. Consequently, it becomes possible to set the circumferential spaces between the connecting portions of the stator winding 23 constant in the radial direction of the stator core 22, thereby preventing a short circuit from occurring between the connecting portions.

In the present embodiment, as shown in FIG. 8, each of the teeth 26 of the stator core 22 has a major portion 26a that faces the inserted portions (i.e., the conductors 231a, 232a, 232b, and 231b) of the stator winding 23 in the circumferential direction of the stator core 22. For each of the teeth 26, the circumferential width of the major portion 26a at a radially inner end of the major portion 26a is equal to that at a radially outer end of the major portion 26a. Moreover, for each of the slots 25 of the stator core 22, the minimum circumferential gaps between the inserted portions of the stator winding 23 in the slot 25 and the major portions 26a of the teeth 26 which face the inserted portions are equal to each other. Furthermore, in the present embodiment, for each of the teeth 26 of the stator core 22, the circumferential width of the major portion 26a is constant in the radial direction of the stator core 22. Consequently, the major portion 26a has a pair of flat side faces that are opposite to each other in the circumferential direction of the stator core 22.

With the above configuration, it is possible to optimize the magnetic circuit formed in the stator 2 while ensuring a high space factor of the stator 2.

FIG. 9 shows a modification of the stator core 22. In this modification, the shapes of the side faces of the teeth 26 are tailored to those of the side faces of the inserted portions (i.e., the conductors 231a, 232a, 232b, and 231b) of the stator winding 23. More specifically, the side faces of the teeth 26 are stepped in the radial direction of the stator core 22. Consequently, for each of the slots 25, the circumferential gaps between the inserted portions of the stator winding 23 in the slot 25 and the major portions 26a of the teeth 26 which face the inserted portions are constant in the radial direction of the stator core 22.

With the above modification, it is also possible to optimize the magnetic circuit formed in the stator 2 while ensuring a high space factor of the stator 2.

In the present embodiment, the stator winding 23 includes a plurality of connecting portions 231f and 232f that are located outside of the slots 25 of the stator core 22 to connect the inserted portions of the stator winding 23. Each of the connecting portions 231f and 232f has a rectangular cross section with a pair of long sides and a pair of short sides, and connects a pair of the inserted portions of the stator winding 23 (i.e., a pair of the conductors 231a and 231b or a pair of the conductors 231a and 231b). Each of the connecting portions 231f and 232f consists of a radially inner portion (231f1 or 232f1), a radially outer portion (231f2 or 232f2), and a turn portion (231c or 232c) between the radially inner and radially outer portions. The radially inner portion (231f1 or 232f1) extends, from the radially inner one (the conductor 231a or 232a) of the pair of the inserted portions, toward the turn portion (231c or 232c) in the circumferential direction of the stator core 22 and away from the stator core 22 in the axial direction. The turn portion (231c or 232c) is, in the connecting portion (231f or 232f), furthest from the stator core 22. The radially outer portion (231f2 or 232f2) extends, from the turn portion (231c or 232c), toward the radially outer one (the conductor 231b or 232b) of the pair of the inserted portions in the circumferential direction of the stator core 22 and toward the stator core 22 in the axial direction. In the radially inner portion (231f1 or 232f1), the connecting portion (231f or 232f) has the long sides of its cross section arranged parallel to the radial direction of the stator core 22. In the radially outer portion (231f2 or 232f2), the connecting portion (231f or 232f) has the long sides of its cross section arranged perpendicular to the radial direction of the stator core 22. In the turn portion (231c or 232c), the arrangement direction of the long sides of the cross section of the connecting portion (231f or 232f) is smoothly turned by 90°.

With the above configuration, for each of the connecting portions 231f and 232f, the side faces of the radially inner portion (231f1 or 232f1) and radially outer portion (231f2 or 232f2) on the outside of the turn of the turn portion (231c or 232c) are smoothly joined to each other; those on the inside of the turn of the turn portion are also smoothly joined to each other. Consequently, it is possible to effectively reduce stresses induced in the connecting portions 231f and 232f and reliably prevent the insulating coats covering the connecting portions 231 and 232f from being damaged.

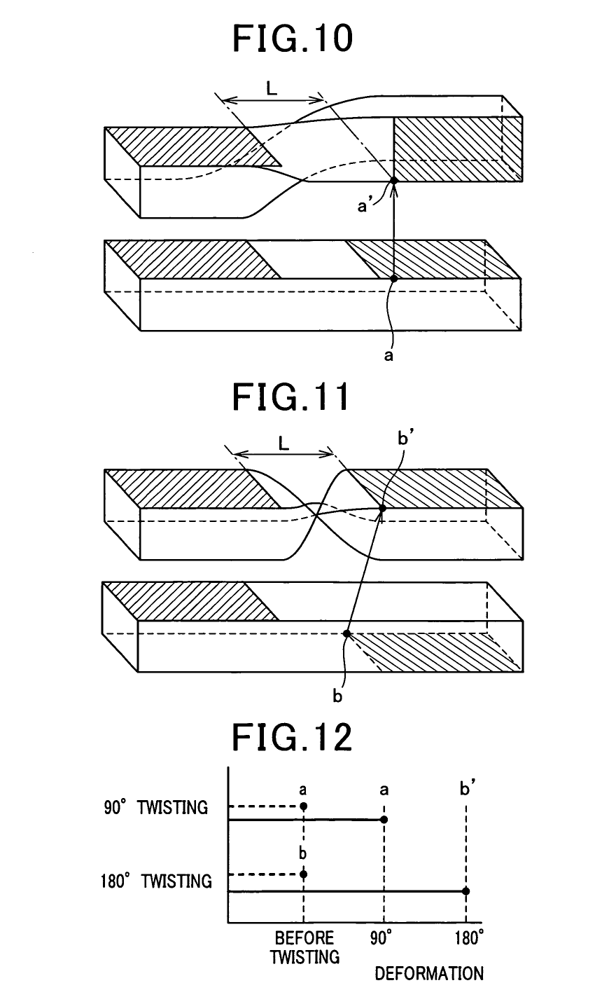

FIG. 10 illustrates the deformation of an electrical conductor with a square cross section caused by 90° twisting. As shown, in this case, a point a in the electrical conductor is displaced to a point a′ after the twisting. Therefore, the amount of deformation caused by the twisting can be represented by the distance between the points a and a′.

On the other hand, FIG. 11 illustrates the deformation of an electrical conductor with a square cross section caused by 180° twisting. As shown, in this case, a point b in the electrical conductor is displaced to a point b′ after the twisting. Therefore, the amount of the deformation caused by the twisting can be represented by the distance between the points b and b′.

FIG. 12 gives a comparison between the deformations of the electrical conductors caused by 90° twisting and 180° twisting. In addition, in FIG. 12, the dashed lines represent the initial lengths of sides of the electrical conductors before performing the twisting processes.

As can be seen from FIG. 12, in the case of 90° twisting, the amount of the deformation caused by the twisting (i.e., the distance between a and a′) is approximately equal to the initial length of one side of the electrical conductor. On the other hand, in the case of 180° twisting, the amount of the deformation caused by the twisting (i.e., the distance between b and b) is approximately twice the initial length of one side of the electrical conductor. Therefore, the amount of the deformation caused by 90° twisting is approximately half that of the deformation caused by 180° twisting.

Consequently, with the reduced amount of the deformation, it is possible to more reliably prevent the insulating coats covering the conductor segments 231 and 232 from being damaged during the formation of the stator winding 23. Moreover, with a given size of the cross section, the stator winding 23 can be used at a smaller slot pith of the stator core 22. Otherwise, with a given slot pitch of the stator core 22, the stator winding 23 can have a larger cross section, thereby increasing the efficiency of the alternator 3.

While the above particular embodiment of the invention has been shown and described, it will be understood by those skilled in the art that various modifications, changes, and improvements may be made without departing from the spirit of the invention.

For example, in the previous embodiment, the conductor segments 231 and 232, which together make up the stator winding 23, each have a rectangular cross section with a pair of long sides and a pair of short sides.

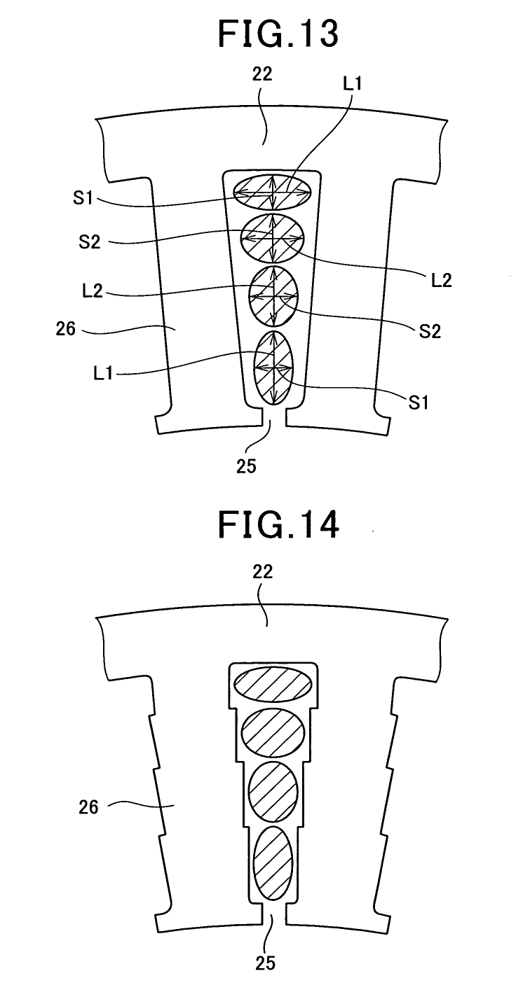

However, as shown in FIGS. 13 and 14, each of the conductor segments 231 and 232 may also have an elliptical cross section with a major axis Li and a minor axis Si, i=1, 2, . . . , n. In addition, in FIG. 13, the side faces of the teeth 26 of the stator core 22 are made flat as in FIG. 8; in FIG. 14, the side faces are stepped in the radial direction of the stator core 22 as in FIG. 9.

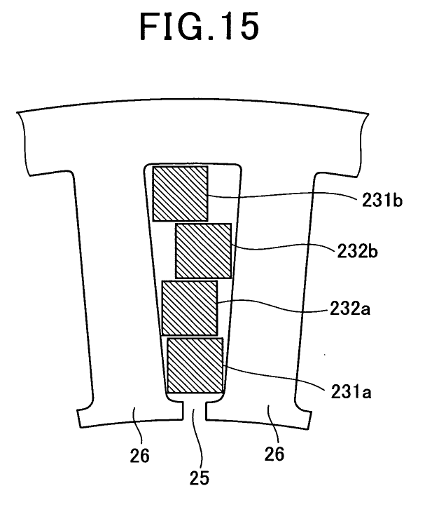

Moreover, as shown in FIG. 15, each of the conductor segments 231 and 232 may also have a square cross section with four equal sides.

Furthermore, it is also possible to form the stator winding 23 with conductor segments having a circular cross section. More specifically, parts of the conductor segments can be pressed to change the circular cross section into a rectangular or elliptical cross section, forming the inserted portions of the stator winding 23. At the same time, the remaining parts of the conductor segments which are not pressed can form the connecting portions of the stator winding 23. As a result, in the stator winding 23, the inserted portions have the rectangular or elliptical cross section, while the connecting portions have the circular cross section. In the case of forming the stator winding 23 in the above way, it is possible to remarkably improve the productivity by adopting the configuration of the stator 2 according to the present invention.

What is claimed is:

1. A stator for a rotating electric machines the stator comprising:
a hollow cylindrical stator core having a plurality of slots formed therein, the slots being arranged in a circumferential direction of the stator core at predetermined intervals; and
a stator winding mounted on the stator core, the stator winding including a plurality of inserted portions, which are inserted in the slots of the stator core, and a plurality of connecting portions that are located outside of the slots to connect the inserted portions,
wherein
each of the inserted portions of the stator winding has a rectangular cross section with a pair of long sides and a pair of short sides or an elliptical cross section with a major axis and a minor axis,
for each of the slots, those of the inserted portions of the stator winding which are inserted in the slot are aligned in a radial direction of the stator core and sorted into first and second groups, the first group of the inserted portions being located radially inside of the second group of the inserted portions,
each of the inserted portions of the first group has the short sides or minor axis of its cross section arranged perpendicular to the radial direction of the stator core,
each of the inserted portions of the second group has the long sides or major axis of its cross section arranged perpendicular to the radial direction of the stator core, and
the width of each of the slots of the stator core in the circumferential direction of the stator core increases in a radially outward direction of the stator core.

2. The stator as set forth in claim 1, wherein in each of the slots of the stator core, there are inserted n pairs of the inserted portions of the stator winding, where n is an integer greater than or equal to 2,
the n pairs have different ratios of length between Si and Li, where Si represents the cross section short sides or minor axis of the i^{th} pair, and Li represents the cross section long sides or major axis of the i^{th} pair, i=1, 2, . . . , n,
the two inserted portions of each of the n pairs are respectively sorted into the first and second groups,
all the inserted portions of the first group are arranged in the radially outward direction of the stator core in the order of S1, S2, . . . , Sn−1, Sn,
all the inserted portions of the second group are arranged in the radially outward direction of the stator core in the order of Ln, Ln−1, . . . , L2, L1, and
S1≦S2≦ . . . ≦Sn−1≦Sn≦Ln≦Ln−1, ≦Ln, . . . , ≦L2≦L1.

3. The stator as set forth in claim 2, wherein each of the connecting portions of the stator winding has a rectangular cross section with a pair of long sides and a pair of short sides or an elliptical cross section with a major axis and a minor axis,
each of the connecting portions connects a pair of the inserted portions of the stator winding which are respectively inserted in a pair of the slots of the stator core and located at different radial positions,
each of the connecting portions consists of a radially inner portion, a radially outer portion, and a turn portion between the radially inner and radially outer portions,
the radially inner portion extends, from the radially inner one of the pair of the inserted portions, toward the turn portion in the circumferential direction of the stator core and away from the stator core in the axial direction,
the turn portion is, in the connecting portion, furthest from the stator core,
the radially outer portion extends, from the turn portion, toward the radially outer one of the pair of the inserted portions in the circumferential direction of the stator core and toward the stator core in the axial direction,
in the radially inner portion, the connecting portion has the long sides or major axis of its cross section arranged parallel to the radial direction of the stator core,
in the radially outer portion, the connecting portion has the long sides or major axis of its cross section arranged perpendicular to the radial direction of the stator core, and
in the turn portion, the arrangement direction of the long sides or major axis of the cross section of the connecting portion is smoothly turned by 90°.

4. The stator as set forth in claim 1, wherein each of the connecting portions of the stator winding has a circular cross section.

5. The stator as set forth in claim 1, wherein the stator core has a plurality of teeth each of which is formed between a pair of the slots in the circumferential direction of the stator core and has a major portion that faces the inserted portions of the stator winding in the pair of the slots in the circumferential direction, and
for each of the teeth, the circumferential width of the major portion at a radially inner end of the major portion is equal to that at a radially outer end of the major portion.

6. The stator as set forth in claim 5, wherein in each of the slots of the stator core, all the minimum circumferential gaps between the inserted portions of the stator winding and the major portions of the teeth which face the inserted portions are equal.

7. The stator as set forth in claim 5, wherein for each of the teeth of the stator core, the circumferential width of the major portion is constant in the radial direction of the stator core.

8. The stator as set forth in claim 5, wherein in each of the slots of the stator core, the circumferential gaps between the inserted portions of the stator winding and the major portions of the teeth which face the inserted portions are constant in the radial direction of the stator core.

9. A stator for a rotating electric machine, the stator comprising:
a hollow cylindrical stator core having a plurality of slots formed therein, the slots being arranged in a circumferential direction of the stator core at predetermined intervals; and
a stator winding mounted on the stator core, the stator winding including a plurality of inserted portions, which are inserted in the slots of the stator core, and a plurality of connecting portions that are located outside of the slots to connect the inserted portions,
wherein
each of the inserted portions of the stator winding has a rectangular cross section with a pair of long sides and a pair of short sides or an elliptical cross section with a major axis and a minor axis,
for each of the slots, those of the inserted portions of the stator winding which are inserted in the slot are aligned in a radial direction of the stator core,
each of the connecting portions of the stator winding has a rectangular cross section with a pair of long sides and a pair of short sides or an elliptical cross section with a major axis and a minor axis,
each of the connecting portions connects a pair of the inserted portions of the stator winding which are respectively inserted in a pair of the slots of the stator core and located at different radial positions,
each of the connecting portions consists of a radially inner portion, a radially outer portion, and a turn portion between the radially inner and radially outer portions,
the radially inner portion extends, from the radially inner one of the pair of the inserted portions, toward the turn portion in the circumferential direction of the stator core and away from the stator core in the axial direction,
the turn portion is, in the connecting portion, furthest from the stator core,
the radially outer portion extends, from the turn portion, toward the radially outer one of the pair of the inserted portions in the circumferential direction of the stator core and toward the stator core in the axial direction,
in the radially inner portion, the connecting portion has the long sides or major axis of its cross section arranged parallel to the radial direction of the stator core,
in the radially outer portion, the connecting portion has the long sides or major axis of its cross section arranged perpendicular to the radial direction of the stator core, and
in the turn portion, the arrangement direction of the long sides or major axis of the cross section of the connecting portion is smoothly turned by 90°.

10. The stator as set forth in claim 9, wherein in each of the slots of the stator core, the inserted portions of the stator winding are sorted into first and second groups, the first group of the inserted portions being located radially inside of the second group of the inserted portions,
each of the inserted portions of the first group has the short sides or minor axis of its cross section arranged perpendicular to the radial direction of the stator core,
each of the inserted portions of the second group has the long sides or major axis of its cross section arranged perpendicular to the radial direction of the stator core, and
the width of each of the slots of the stator core in the circumferential direction of the stator core increases in a radially outward direction of the stator core.

11. The stator as set forth in claim 10, wherein the stator core has a plurality of teeth each of which is formed between a pair of the slots in the circumferential direction of the stator core and has a major portion that faces the inserted portions of the stator winding in the pair of the slots in the circumferential direction, and
for each of the teeth, the circumferential width of the major portion at a radially inner end of the major portion is equal to that at a radially outer end of the major portion.

12. The stator as set forth in claim 11, wherein in each of the slots of the stator core, all the minimum circumferential gaps between the inserted portions of the stator winding and the major portions of the teeth which face the inserted portions are equal.

13. The stator as set forth in claim 11, wherein for each of the teeth of the stator core, the circumferential width of the major portion is constant in the radial direction of the stator core.

14. The stator as set forth in claim 11, wherein in each of the slots of the stator core, the circumferential gaps between the inserted portions of the stator winding and the major portions of the teeth which face the inserted portions are constant in the radial direction of the stator core.

15. The stator as set forth in claim 9, wherein each of the inserted portions of the stator winding has a square cross section with four equal sides.
